(19) United States
(12) Patent Application Publication
(10) Pub. No.: US 2023/0297229 A1
(43) Pub. Date: Sep. 21, 2023

(54) SYSTEMS AND METHODS FOR MANAGING GRAPHICAL USER INTERFACES ON MOBILE DEVICES

(71) Applicant: Shopify Inc., Ottawa (CA)

(72) Inventors: Niklas ITÄNEN, Ottawa (CA); Hettige Ray Perera JAYATUNGA, Toronto (CA)

(73) Assignee: Shopify Inc., Ottawa (CA)

(21) Appl. No.: 17/699,512

(22) Filed: Mar. 21, 2022

(51) Int. Cl. G06F 3/04883; G06F 3/0482; G06F 3/01; G06F 3/041; G06F 3/0484

(52) U.S. Cl. CPC G06F 3/04883; G06F 3/0482; G06F 3/016; G06F 3/041; G06F 3/0484; G06F 2203/04105

(57) ABSTRACT

A computer-implemented method is disclosed. The method includes: detecting, via a touch-sensitive interface, a first touch input corresponding to selection of a user interface element associated with a first menu level of a hierarchical menu; detecting a continuous touch gesture starting with the first touch input; determining a current selection of menu item of the first menu level based on a current location of contact; detecting, at a first time, a trigger condition in connection with the contact; in response to detecting the trigger condition: cause to be displayed, via a display device, a graphical representation of a second menu level of the hierarchical menu; detecting, at a second time, an end of the continuous touch gesture; responsive to detecting the end of the continuous touch gesture, determining a selection of menu item of the second menu level based on a location of the contact at the second time.

### TECHNICAL FIELD

The present disclosure relates to graphical user interfaces, and more particularly to, systems and methods for managing display of and user interaction with menu components on mobile computing devices.

### BACKGROUND

The convenience of mobile devices, such as smartphones and tablets, is expectedly a product of their form factor (i.e., size, shape, etc.). The smaller screen size of mobile devices often limits the types of user interactions that are possible on such devices. For example, in trying to optimize the use of available screen space, the display of certain user interface elements may be compromised (e.g., limited or truncated information, multiple user interface layers for a single user selection, etc.). Furthermore, user input (e.g., touch gestures, selection using a pointing device, etc.) on a smaller screen may result in incorrect selections and be limited in range of positions due to device dimensional constraints.

### BRIEF DESCRIPTION OF THE DRAWINGS

Embodiments will be described, by way of example only, with reference to the accompanying figures wherein:

FIG. 1 illustrates an example system for managing graphical user interfaces for accessing services associated with an e-commerce platform;

FIGS. 2A and 2B show example user interface elements associated with a hierarchical menu;

FIG. 3 shows, in flowchart form, an example method for navigating between levels of a hierarchical menu on a graphical user interface;

FIG. 4 shows, in flowchart form, another example method for navigating between levels of a hierarchical menu on a graphical user interface;

FIG. 5 shows, in flowchart form, another example method for navigating between levels of a hierarchical menu on a graphical user interface;

FIG. 6 shows, in flowchart form, an example method for managing display of sub-menus of a hierarchical menu;

FIG. 7A is a high-level schematic diagram of a computing device;

FIG. 7B shows a simplified organization of software components stored in a memory of the computing device of FIG. 7A;

FIG. 8 is a block diagram of an e-commerce platform, in accordance with an example embodiment; and

FIG. 9 is an example of a home page of an administrator, in accordance with an example embodiment.

Like reference numerals are used in the drawings to denote like elements and features.

### DETAILED DESCRIPTION OF EMBODIMENTS

In an aspect, the present application discloses a computer-implemented method. The method includes: detecting, via a touch-sensitive interface, a first touch input corresponding to selection of a user interface element associated with a first menu level of a hierarchical menu; detecting a continuous touch gesture starting with the first touch input; determining a current selection of menu item of the first menu level based on a current location of contact with the touch-sensitive interface during the continuous touch gesture; detecting, at a first time, a trigger condition in connection with the contact; in response to detecting the trigger condition: cause to be displayed, via a display device, a graphical representation of a second menu level of the hierarchical menu, the second menu level representing a sub-menu associated with the current selection of menu item of the first menu level at the first time; detecting, at a second time, an end of the continuous touch gesture; responsive to detecting the end of the continuous touch gesture, determining a selection of menu item of the second menu level based on a location of the contact at the second time.

In some implementations, the touch-sensitive interface may be a touchscreen that is part of the display device and the continuous touch gesture may be a swiping gesture.

In some implementations, the touch-sensitive interface may be a pointing device having a tactile sensor that is separate from the display device.

In some implementations, detecting the trigger condition may include determining that an amount of force applied to the touch-sensitive interface at the current location of contact exceeds a defined force threshold.

In some implementations, detecting the trigger condition may include determining that the contact has been maintained at a location on the touch-sensitive interface corresponding to a menu item for a duration that exceeds a defined threshold length of time.

In some implementations, detecting the end of the continuous touch gesture may include detecting a release of the contact with the touch-sensitive interface.

In some implementations, the user interface element associated with the first menu level may be a first radial menu container element that contains a plurality of discrete first menu item user interface components.

In some implementations, the graphical representation of the second menu level may be a menu user interface that contains a continuous spectrum menu user interface element.

In some implementations, causing to be displayed the graphical representation of the second menu level may include causing a second radial menu container element to be displayed as an overlay on the first radial menu container, the second radial menu container element containing a plurality of discrete second menu item user interface elements associated with a selected one of the first menu items.

In some implementations, the first radial menu container element may be a base hue selector menu and the second radial menu container element may be a color spectrum menu corresponding to a selected base hue.

In some implementations, the method may further include providing, via the touch-sensitive interface, at least one of a graphical indication of the current selection of menu item of the first menu level or a graphical indication of the current selection of menu item of the second menu level.

In some implementations, the method may further include providing haptic feedback for indicating a change of the current selection of menu item of the first menu level during the continuous touch gesture.

In another aspect, the present application discloses a computing system including a processor and a memory coupled to the processor. The memory stores computer-executable instructions that, when executed, configure the processor to: detect, via a touch-sensitive interface, a first touch input corresponding to selection of a user interface element associated with a first menu level of a hierarchical menu; detect a continuous touch gesture starting with the first touch input; determine a current selection of menu item of the first menu level based on a current location of contact with the touch-sensitive interface during the continuous touch gesture; detect, at a first time, a trigger condition in connection with the contact; in response to detecting the trigger condition: cause to be displayed, via a display device, a graphical representation of a second menu level of the hierarchical menu, the second menu level representing a sub-menu associated with the current selection of menu item of the first menu level at the first time; detect, at a second time, an end of the continuous touch gesture; responsive to detecting the end of the continuous touch gesture, determine a selection of menu item of the second menu level based on a location of the contact at the second time.

In yet another aspect, the present application discloses a non-transitory, computer readable storage medium. The medium may store processor-executable instructions that, when executed, cause one or more processors to carry out the operations of one or more of the methods or processes described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and associated payment requests, via an e-commerce platform, and the e-commerce platform may be equipped with transaction/payment processing components or delegate such processing activities to one or more third-party services. An e-commerce platform may be extendible/extensible by connecting one or more additional sales channels representing platforms where products can be sold. In particular, the sales channels may themselves be e-commerce platforms, such as Facebook Shops™, Amazon™, etc. The e-commerce platform may serve one merchant in some implementations. The e-commerce platform may be a multi-merchant platform in other cases, where each merchant is able to use some or all of the available services to configure an online storefront and provide commerce services to customers of the online storefront. A multi-merchant e-commerce platform may operate across a range of geographic regions, and may operate in multiple countries, currencies, and time zones.

### Navigating Graphical User Interfaces on Mobile Devices

The limited screen space on mobile devices for display output and gesture-based user input underscores the importance of user interface and interaction design. It is generally desired to optimize use of screen space in order to conveniently and effectively present information to users of mobile devices. This principle also applies to the e-commerce context. Customers use mobile devices to access various e-commerce channels (e.g., websites, retail applications, etc.). A user interface for an e-commerce channel that is optimized for mobile devices may facilitate effective presentation of product-related information to customers and thereby make for an enhanced overall e-commerce experience.

A popular technique for economizing on screen space on mobile devices is the use of menus within graphical user interfaces. A menu presents a list of options or commands, and users can select an item from the menu in order to initiate an associated action (e.g., page navigation, file/system operation, setting a value, etc.). Rather than persistently displaying all of the options and associated content (e.g., text, symbols, etc.) on the graphical user interface, a menu can save screen space by collapsing the menu items into a modular control element, such as a menu bar, a drop-down list, and the like, while still allowing easy user access to the options.

Menus are often hierarchically organized, with the menu content being arranged into multiple levels. In particular, a hierarchical menu having a cascading structure may include a top-level menu and one or more sub-menus. Selecting a menu item from the top-level menu expands a sub-menu with options that are associated with the selected item. The menu options of a menu level may be represented as discrete items or by continuous data (e.g., shades of a color, volume, brightness, etc.).

While the layering of menu items offers the benefit of saving screen space, hierarchical menus are sometimes associated with suboptimal usability on mobile devices. In order to access sub-menu content, users must first select a menu entry from a higher-level menu and subsequently navigate to a desired one of the sub-menu entries. For mobile devices, a hierarchical menu may be presented in a compact graphical form such that each menu entry component occupies a small amount of space and is adjoined by one or more menu entry components. As a consequence, navigating the menu may be slow and any errors in selecting the boundaries of a higher-level menu entry component may result in hiding/collapsing the associated sub-menu. When such menus are used for making a user selection or setting a value, the compact form of the menu may lead to errors in selection and require corrective action.

Furthermore, for hierarchical menus, users must perform a series of actions in order to select a sub-menu item. In particular, the user navigates at least one higher-level menu component prior to reaching a desired sub-menu entry. Depending on the structure of a hierarchical menu, multiple discrete actions may be required to make a single selection, resulting in increased processing burden for handling user input actions and display of menu components.

The present application describes solutions for addressing some of the aforementioned technical limitations associated with conventional graphical user interfaces. Systems and methods for navigating hierarchical menu user interfaces on a mobile device are disclosed. Specifically, the disclosed methods allow a user to select a menu item from a hierarchical menu using a single continuous touch gesture. A “continuous” touch gesture refers to a user gesture, such as a swiping or scrolling gesture, inputted on a touch-sensitive surface in which contact is continuously maintained with the surface throughout the gesture. In an example implementation, a graphical user interface for a color selector tool may include multiple levels of selection corresponding to, at least, (1) selection of a base hue from a plurality of discrete choices (e.g., an RGB color wheel), and (2) selection(s) of shade/tint/tone from a continuous spectrum of choices that may be associated with a selection in the previous level of the hierarchy. In accordance with the disclosed methods, a mobile device may process a single continuous touch gesture in connection with the color selector component to detect user selection of a color, i.e., base hue+shade/tint/tone. More generally, the disclosed methods may allow a mobile device to handle selection of menu items in hierarchical menus having (1) a first menu level represented by discrete choices, and (2) a plurality of sub-menus which may contain choices represented by continuous data.

A mobile device detects, via a touch-sensitive display, a first touch input corresponding to selection of a menu component, such as a color selector component. Specifically, the first touch input is detected while the user interface element associated with the first level of a hierarchical menu is displayed. For example, the location of the detected first touch input may correspond to an area of the touch-sensitive display where the menu component is displayed. Subsequent to the first touch input, the mobile device detects a touch gesture (e.g., a scroll gesture corresponding to a user scroll event) continuous from the first touch input. That is, the first touch input represents a starting point of a continuous touch gesture.

The user navigates through the menu items of the first level using the touch gesture. In particular, the mobile device is configured to determine a menu item selection corresponding to a current location of the user's touch input during the touch gesture. As the user continues swiping, the current menu item selection is updated. In some implementations, the mobile device may provide indications of the current menu item selection (e.g., graphically highlighting the current selection) and/or the user's movement between the menu items (e.g., haptic feedback as current menu item selection is changed due to the user's touch gesture).

The mobile device may detect user selection of a menu item from the first menu level in various ways. The mobile device may detect, for example, that the pressure and/or contact area of the touch input exceeds a defined threshold or that a dwell time on a menu item selection exceeds a defined threshold length of time. Upon detecting the user selection, the mobile device advances to the next menu level by providing a graphical representation of a sub-menu. The sub-menu represents a menu that is associated with the selected menu item from the first level. The user may further navigate the second menu level by continuing the touch gesture. When the mobile device detects that the continuous gesture has ended (i.e., release of the contact with the touchscreen), the mobile device registers the selection of a choice associated with the location of the touch input immediately prior to the end of the continuous gesture.

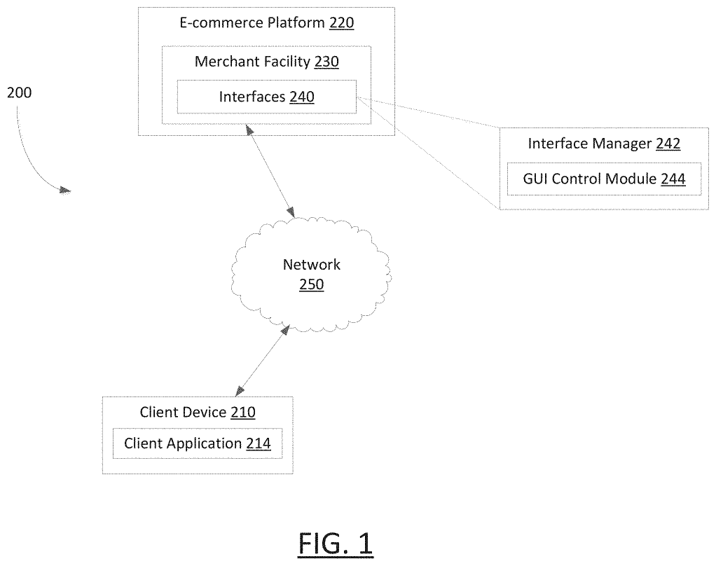

Reference is first made to FIG. 1, which illustrates, in block diagram form, an example system 200 for managing graphical user interfaces on computing devices. Specifically, the components of system 200 may cooperate to facilitate managing the display of and interaction with user interface elements on mobile devices. As shown in FIG. 1, the system 200 may include client devices 210, an e-commerce platform 220, a merchant facility 230, and a network 250 connecting the components of system 200. The graphical user interfaces on client devices 210 for accessing services associated with the merchant facility 230 may be adapted in accordance with one or more of the disclosed methods of the present application.

As illustrated, the client device 210 and the merchant facility 230 can communicate via the network 250. In at least some embodiments, the client device 210 may be a computing device. The client device 210 may take a variety of forms including, for example, a mobile communication device such as a smartphone, a tablet computer, a wearable computer (such as a head-mounted display or smartwatch), a laptop or desktop computer, or a computing device of another type. The client device 210 includes, at least, a client application 214. The client application 214 may be, for example, a dedicated retail application associated with an e-commerce platform and/or a merchant. In particular, the client application 214 may be used for accessing an e-commerce platform and/or a merchant's online store on the client device 210.

The merchant facility 230 represents a computing system associated with a specific merchant. As shown in FIG. 1, the merchant facility 230 may be provided by or integrated in an e-commerce platform 220. In particular, the e-commerce platform 220 may provide merchant facilities 230 for a plurality of merchants that are associated with the e-commerce platform 220. In at least some embodiments, the merchant facility 230 may be a backend server associated with a merchant's online store. For example, the merchant facility 230 may be an application server associated with an online point-of-sale (e.g., website, mobile application, etc.) that is operated by a merchant. The online point-of-sale may be accessed by a customer via a user interface, provided by the application server, on the client device 210. Additionally, or alternatively, the merchant facility 230 may be integrated with an e-commerce platform. In particular, the merchant facility 230 may be associated with one or more storefronts of a merchant that are supported by an e-commerce platform. A merchant's online e-commerce service offerings may be provided via the merchant facility 230.

The merchant facility 230 may include an interfaces module 240. The interfaces module 240 includes components, such as an interface manager 242, for managing interfaces associated with various e-commerce channels through which a merchant offers their products. In particular, the interface manager 242 may implement a graphical user interface (GUI) control module 244. The GUI control module 244 may be configured to generate, control, and update GUIs such as, for example, a web user interface, a mobile application GUI, and the like, by which customers can access a merchant's online storefronts.

The network 250 is a computer network. In some embodiments, the network 250 may be an internetwork such as may be formed of one or more interconnected computer networks. For example, the network 250 may be or may include an Ethernet network, an asynchronous transfer mode (ATM) network, a wireless network, or the like.

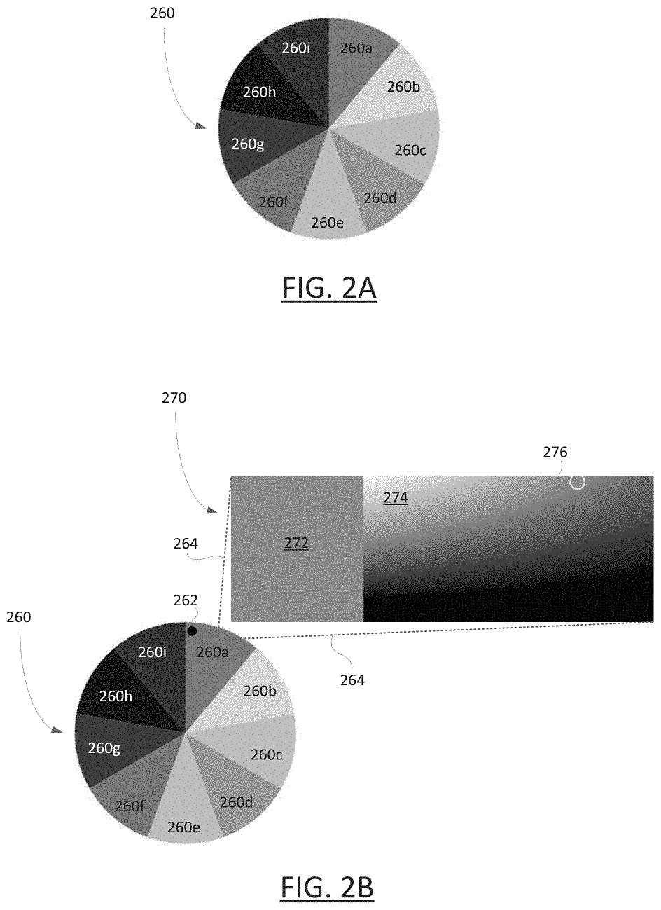

The methods disclosed in the present application relate to control of menu components within graphical user interfaces. An example implementation of a hierarchical menu is illustrated in FIGS. 2A-2B. FIG. 2A shows an example first menu element 260 associated with a top-level menu of a hierarchical menu. In the illustrated example, the first menu element 260 is a radial menu container element that contains a plurality of discrete menu item components 260a-260i. In some embodiments, the first menu element 260 may be a “pie menu”, a graphical control element where item selection depends on direction. A pie menu is a circular contextual menu that includes a plurality of menu items positioned around an inactive center. Selection of a menu item is made based on relative direction of the user input (i.e., touch gesture, cursor movement, etc.). In particular, a “slice” associated with a menu item is selected from a pie menu by movement of a pointer element in the direction of the slice. A pie menu may be faster and more reliable than linear menus in some cases since pointing requires minimal cursor motion and the larger area and wedge shape of “slices” make them easy targets for selection.

FIG. 2B shows menu components associated with multiple levels of a hierarchical menu. Specifically, a first menu element 260 associated with a top-level menu and a second menu element 270 associated with a sub-menu are shown. The sub-menu is associated with a specific one (i.e., 260a) of the menu item components 260a-260i. That is, the second menu element 270 graphically presents only the menu options of a sub-menu that is associated with the top-level menu item 260a. Advantageously, by limiting the menu options/choices available for selection in the second menu element 270 to only those that are associated with a specific item from the top-level menu, the user can be presented with only the menu content that is relevant to their expressed choice(s).

In at least some embodiments, the user interface elements of FIG. 2B may be used to provide a graphical representation of a selection utility, such as a color selector tool. For example, the first menu element 260 may be associated with a base hue selector menu and the second menu element 270 may be associated with a color spectrum menu corresponding to a selected base hue. A user selection of a menu item of the top-level menu may be indicated graphically on the first user interface element 260, for example, by a selection indicator 262. As another example, the user interface elements of FIG. 2B may be part of a control panel utility. The control panel utility may be used, for example, to adjust sound settings on a mobile device. The first menu element 260 may be associated with a top-level menu containing options including, for example, bass, treble, mid, balance, and fade, and the second menu element 270 may be associated with a sub-menu corresponding to a selected one of the top-level menu items. The second menu element 270 may, for example, be a control element such as a slider for controlling a relevant variable (e.g., volume).

As shown in FIG. 2B, the second menu element 270 may include, at least, a sub-menu indicator 272 and a menu options section 274. The sub-menu indicator 272 graphically represents content of the sub-menu associated with the second menu element 270. In the example of FIG. 2B, the sub-menu indicator 272 may represent a base hue corresponding to the selected top-level menu item 260a. By default, the content of the sub-menu indicator 272 may be set to be same as the content of the top-level menu item 260a. For example, the sub-menu indicator 272 may initially be set as the hue associated with the top-level menu item 260a. The menu options section 274 presents options associated with the sub-menu. The options may be represented as discrete items or by continuous data, such as a continuous color spectrum associated with a selected base hue. The color spectrum may, for example, correspond to a continuum representing different shades, tints, and/or tones for the selected base hue.

In at least some embodiments, the sub-menu indicator 272 may represent a current hue associated with a position indicated by a selection indicator 276 of FIG. 2B. In particular, the sub-menu indicator 272 may be dynamically updated based on user interaction with the second menu element 270. For example, the selection indicator 276 may be moved in the second menu element 270 (and specifically, in the menu options section 274) in accordance with a user's touch gesture, and the sub-menu indicator 272 may be updated to display the hue that corresponds to the user's current selection (as represented by location of the selection indicator 276) from the menu options section 274.

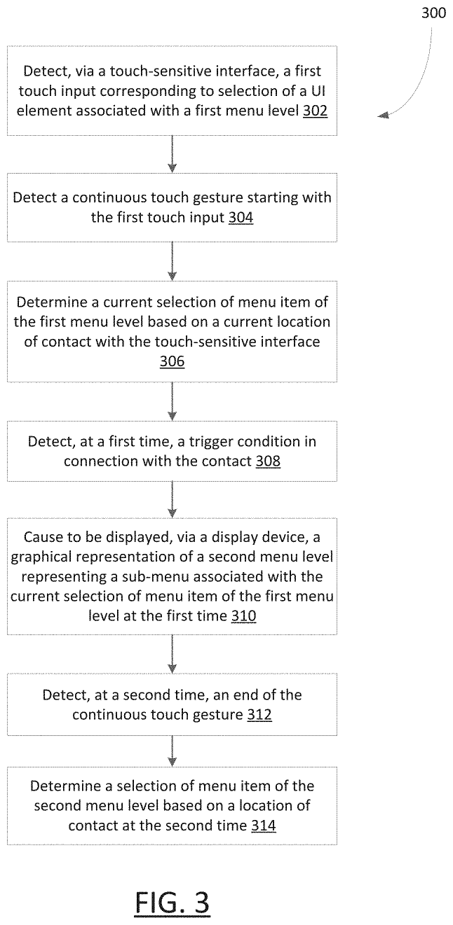

Reference is now made to FIG. 3, which shows, in flowchart form, an example method 300 for navigating between levels of a hierarchical menu on a graphical user interface. The method 300 may be performed by a computing system associated with one or more merchant facilities, such as the e-commerce platform 220 of FIG. 1. For example, a merchant facility (such as the merchant facility 230) of an e-commerce platform, or components thereof (such as the interfaces module 240), may perform the operations of method 300 for managing graphical user interfaces on client devices. In particular, a computing system that is configured for providing graphical user interfaces for client devices and processing user interaction data obtained via client devices may implement the method 300.

A computing system associated with a merchant facility may provide a menu component for a hierarchical menu within a graphical user interface on client devices. For example, a web user interface or the GUI of a mobile application for a merchant's online storefront may include a hierarchical menu. In some embodiments, a graphical user interface associated with an online storefront may implement a hierarchical menu as part of a product selection functionality. For example, a menu that includes top-level choices for a product attribute (e.g., base hue) and one or more sub-menus for indicating specific options associated with the selected top-level choice (e.g., shade/tine/tone) may be provided via the graphical user interface. The menu may allow a customer to select product attributes for a product that they wish to view and/or purchase. By navigating a hierarchical menu for attribute selection, the customer may be able to identify their desired product attributes with greater degree of granularity as compared to selecting from a single set of discrete options. Conveniently, users with less dexterity or no need to make granular choices may effectively ignore the sub-menus, while other users are able to access a greater range of options (e.g., product attributes) by means of sub-menu selections.

On mobile devices that are equipped with touch sensing technologies, the menu component may be activated by a user's touch input. Specifically, in operation 302, the computing system detects, via a touch-sensitive interface, a first touch input corresponding to selection of a user interface element associated with a first menu level. The touch-sensitive interface may, for example, be a touchscreen that is part of a client device. The touch input may be detected at the client device, for example, when contact is first made on the touch-sensitive interface using an input means (e.g., the user's finger, stylus, etc.). Upon detecting the initial contact, the client device may transmit a signal containing information about the detected touch input to the computing system.

In operation 304, a continuous touch gesture starting with the first touch input is detected. The touch gesture may, for example, be a swiping gesture or a scrolling gesture that is continuous from the first touch input on the touch-sensitive interface. As explained above, a continuous touch gesture maintains contact between the input means and the touch-sensitive interface throughout the gesture.

The continuous touch gesture may be determined to be part of a user input for manipulating the menu component associated with the hierarchical menu. For example, a swiping or scrolling gesture may correspond to a rotating, shifting, or otherwise alternating through the menu items of the first menu level. The location of the contact throughout the touch gesture allows for determining the user's virtual selection from the first menu level. Specifically, the computing system determines a current menu item selection from the first menu level based on a current location of contact with the touch-sensitive interface, in operation 306. In at least some embodiments, a graphical indicator (such as selection indicator 262 of FIG. 2B) may indicate a current (or default) selection of a menu item from the first menu level, and display of the menu component may be dynamically updated to move the graphical indicator between menu item components when the continuous touch gesture is detected. In particular, the graphical indicator may be moved in accordance with the user's touch gesture. The touch gesture may thus represent a continuous movement of the graphical indicator towards a desired selection of a menu item. The client device may be caused to provide user feedback during the continuous touch gesture, for example, to indicate progress towards the user's desired selection. For example, the client device may provide haptic feedback for indicating a change of current selection of menu item. The current selection may be changed, for example, when the contact location is caused to move across a boundary between adjoining menu options as a result of the touch gesture.

In this way, the computing system is able to track the current virtual selection of a menu item based on monitoring the location of contact detected throughout a continuous touch gesture. In operation 308, a trigger condition in connection with the contact is detected, at a first time. Specifically, the computing system determines that a defined trigger condition associated with the contact is satisfied at the first time. One or more trigger conditions may be defined, and detection of trigger conditions may depend on the hardware capabilities of the client device on which the graphical user interface is presented.

In some embodiments, the trigger condition may relate to an amount of force applied to the touch-sensitive interface of the client device. For client devices that are equipped with a pressure sensitive display, the computing system may determine that a measured amount of force that is applied on the current location of contact at the first time exceeds a defined force threshold. The applied force associated with a press of the user's finger (or pointing device, and the like) may be measured and compared with a threshold value. In particular, the amount of force that is applied on the touch-sensitive interface throughout the touch gesture may be continuously monitored. The computing system may determine that a trigger condition has been satisfied if the measured force exceeds the threshold value based on the comparison.

For client devices that are not equipped with a pressure sensitive display, the trigger condition may relate to measured area of contact on a touch-sensitive interface. In particular, the computing system may infer changes in pressure applied to the touch-sensitive interface based on the measured area of contact between a user's finger (or pointing device, etc.) and the touch-sensitive interface during a detected touch input (e.g., finger press). An increase in the measured contact area may indicate that the user is applying increased pressure during the touch input. If the measured contact area (or increase thereof) is determined to exceed a defined threshold, the computing system may determine that a trigger condition has been satisfied.

In some embodiments, the trigger condition may relate to a dwell time, or a length of time associated with a press action on the touch-sensitive interface. For example, the computing system may detect a trigger condition when the contact is determined to have been maintained at a location on the touch-sensitive interface corresponding to a menu item for a duration that exceeds a defined threshold length of time. If the user's press action at a specific location is determined to last more than a threshold time period (e.g., 3 seconds), the computing system may determine that a trigger condition has been satisfied.

Upon detecting a trigger condition, a sub-menu associated with a current menu item selection is caused to be displayed. Specifically, the computing system causes a graphical representation of a second menu level of the hierarchical menu to be displayed, in operation 310. The graphical representation is displayed via a display device, such as the touchscreen of the client device. The second menu level represents a sub-menu associated with the current selection of menu item of the first menu level at the first time. That is, the sub-menu is associated with a menu item that is determined to be the user's current virtual selection from the first menu level based on the detected location of the contact on the touch-sensitive interface.

The graphical representation of the sub-menu may take various different forms. In some embodiments, the sub-menu component may be displayed as a pop-up menu component that is distinct from the menu component for the first menu level. FIG. 2B illustrates an example embodiment in which the second menu element 270 is displayed as a modal user interface component. The graphical user interface may include a graphical representation of the association between the first menu element 260 and the second menu element 270. For example, in FIG. 2B, the dotted lines 264 provide an indication that the second menu element 270 is associated with the selected menu item 260a from the first menu element 260.

Alternatively, in some embodiments, the sub-menu component may be displayed as an overlay on the menu component for the first menu level. In particular, the sub-menu component may be overlaid over at least a portion of the first menu component. For example, in the example embodiment of FIG. 2A, a second menu element 270 associated with a sub-menu of the selected menu item 260a may be displayed as a radial menu container element that replaces the first menu element 260 on the graphical user interface.

Once the sub-menu component is displayed, the user may continue the touch gesture (e.g., swiping, scrolling, and the like) in order to make a selection from the sub-menu. In at least some embodiments, a graphical indicator, such as a selection indicator 276 of FIG. 2B, may be moved on the sub-menu component in accordance with the user's touch gesture. The user may move the selection indicator 276 by continuing the touch gesture until the selection indicator 276 arrives at a location on the sub-menu component that corresponds to their desired selection of sub-menu choice/option. In operation 312, the computing system detects an end of the continuous touch gesture, at a second time that succeeds the first time. That is, the user's touch gesture is determined to come to an end. In at least some embodiments, the end of the touch gesture may be detected when a release of the contact with the touch-sensitive interface is detected. Responsive to detecting the end of the continuous touch gesture, the computing system determines a selection of a sub-menu item based on a location of the contact at the second time, in operation 314. For example, the selected sub-menu item may correspond to an option/choice associated with a current location of a selection indicator 276 at the time of detected end of the touch gesture.

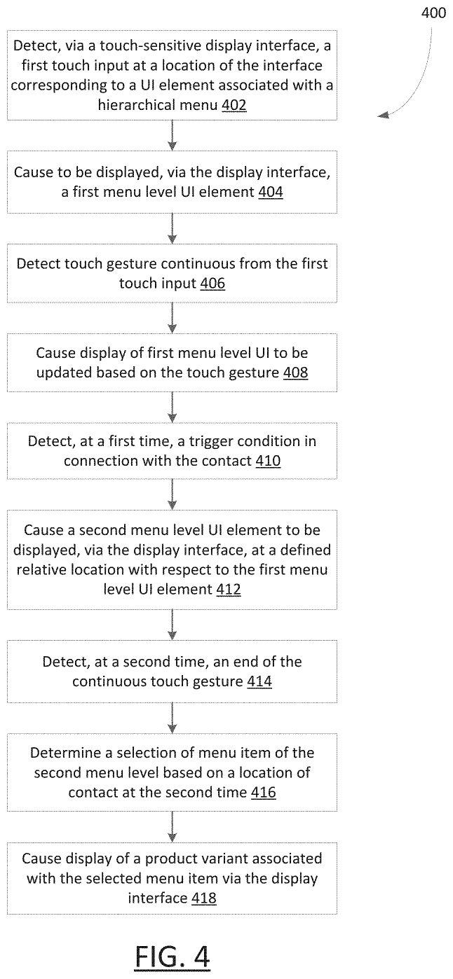

Reference is now made to FIG. 4, which shows, in flowchart form, another example method 400 for navigating between levels of a hierarchical menu on a graphical user interface. The method 400 may be performed by a computing system associated with one or more merchant facilities, such as the e-commerce platform 220 of FIG. 1. For example, a merchant facility (such as the merchant facility 230) of an e-commerce platform, or components thereof (such as the interfaces module 240), may perform the operations of method 400 for managing graphical user interfaces on client devices. In particular, a computing system that is configured for providing graphical user interfaces for client devices and processing user interaction data obtained via client devices may implement the method 400. The operations of method 400 may be performed in addition to, or as alternatives of, one or more operations of method 300.

In at least some implementations, user interaction with the user interface elements of a hierarchical menu may be received directly on a display interface, such as a touchscreen, on which the graphical user interface is presented. In particular, a user's touch gesture for interacting with a hierarchical menu may be inputted directly on the device on which the menu components are displayed. The detected touch gesture causes the display of menu components, including a top-level menu and sub-menu components, to be dynamically updated on the display interface.

In operation 402, the computing system detects, via a touch-sensitive display interface, a first touch input at a location on the interface corresponding to a user interface element associated with a hierarchical menu. For example, a user interface element for expanding or activating a hierarchical menu may be directly pressed by the user using their finger (or pointing device, and the like). The computing system causes a first menu level user interface element to be displayed, in operation 404. In particular, a top-level menu component may be displayed on the interface, graphically representing the menu items associated with the top-level menu.

The computing system and/or the client device monitors for a further touch gesture. In operation 406, a touch gesture that is continuous from the first touch input is detected. The touch gesture may, for example, be a swiping or scrolling gesture that is intended by the user for manipulating the top-level menu component. For example, the user may input a scrolling gesture continuous from the first touch input in order to cause a graphical rotating, shifting, or otherwise alternating between the menu items of the top-level menu.

In operation 408, the first menu level user interface element is caused to be updated based on the detected touch gesture. In some embodiments, a graphical indicator, such as the selection indicator 262, may be moved in accordance with the touch gesture. The graphical user interface may thus be updated to indicate the changing location of the selection indicator 262 on the top-level menu components. Alternatively, in some embodiments, the top-level menu component may itself be represented as being moved. For example, in the example of FIG. 2A, the radial menu container may be graphically represented as being spun about a central axis. A stopper user interface element may be displayed at a fixed relative location with respect to the top-level menu component, such that the user's selection of a menu item from the top-level menu may be indicated by the stopper element. For example, the user may “spin” the top-level menu component by the touch gesture until the stopper element points at the user's desired menu item selection. The user's touch gesture may thus represent a manipulation of the top-level menu component.

In operation 410, a trigger condition in connection with the contact with the touch-sensitive interface is detected. The trigger condition may be any one or more of the trigger conditions described with reference to method 300 of FIG. 3. Responsive to detecting the trigger condition, the computing system causes a sub-menu user interface element to be displayed via the display interface, in operation 412. Specifically, the sub-menu component is caused to be displayed at a defined relative location with respect to the top-menu level component. For example, the sub-menu component may be displayed as a modular control element on the display interface.

The user may continue the touch gesture until arriving at their desired selection of sub-menu item. In particular, a selection indicator (such as the selection indicator 276 of FIG. 2B) may be caused to move on the sub-menu component in accordance with the user's touch gesture. The selection indicator can be moved to a location on the sub-menu component that corresponds to the user's desired sub-menu item selection.

As described with reference to method 300, a selection of a sub-menu item can be made by ending the continuous touch gesture. The computing system may detect, at a second time, an end of the user's continuous touch gesture, in operation 414. For example, a release of the contact with the display interface may be detected. The end of the touch gesture represents the user's confirmation of their sub-menu item selection. That is, the user may maintain contact with the display interface while continuing the touch gesture in order to move a selection indicator to a specific location on the display interface, and release the contact to confirm their selection upon arriving at the location corresponding to their desired selection. In particular, the selected sub-menu item may be determined based on a location of the contact at the second time, in operation 416.

In some embodiments, the user selection of a sub-menu item may be processed further for generating display data on the graphical user interface. For example, in the context of a user interface associated with an e-commerce platform, a customer's selection of a sub-menu item from a hierarchical menu may be applied for determining the desired attributes of a product. A computing system may determine a variant of a product having the selected product attribute(s) and present product data for the variant to the customer. In particular, the computing system may cause display of a product variant associated with the selected sub-menu item via the display interface, in operation 418.

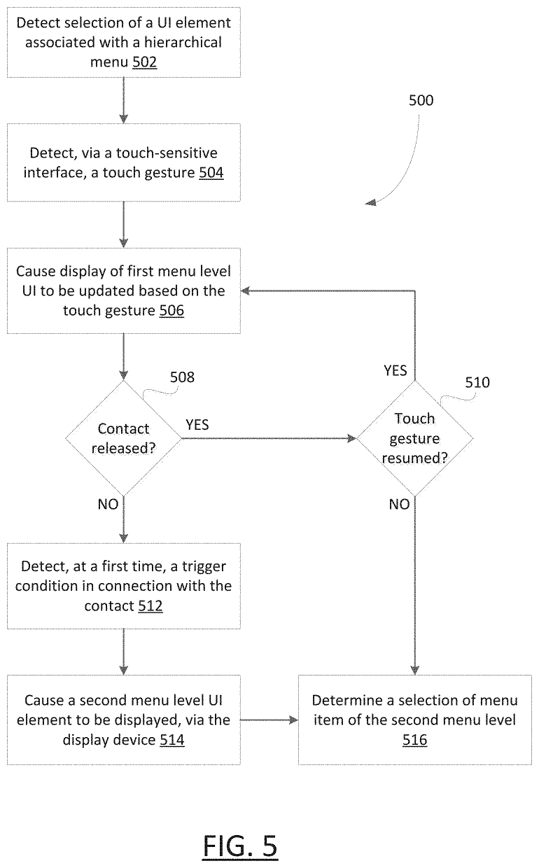

Reference is now made to FIG. 5, which shows, in flowchart form, another example method 500 for navigating between levels of a hierarchical menu on a graphical user interface. The method 500 may be performed by a computing system associated with one or more merchant facilities, such as the e-commerce platform 220 of FIG. 1. For example, a merchant facility (such as the merchant facility 230) of an e-commerce platform, or components thereof (such as the interfaces module 240), may perform the operations of method 500. In particular, a computing system that is configured for providing graphical user interfaces for client devices and processing user interaction data obtained via client devices may implement the method 500. The operations of method 500 may be performed in addition to, or as alternatives of, one or more of the operations of methods 300 and 400.

In some implementations, user interaction with the user interface elements of a hierarchical menu may be received on an interface that is different from a display device on which the graphical user interface is presented. By way of example, an external input device (e.g., a trackpad, or another pointing device having a tactile sensor) associated with a mobile device may be used for inputting touch gestures in connection with a hierarchical menu. In some other implementations, the user interaction may be received at a location on the display device that is different from the location occupied by the menu components of the hierarchical menu. That is, touch gestures that are registered at different locations of the display device may be used to navigate the hierarchical menu.

In operation 502, the computing system detects selection of a user interface element associated with a hierarchical menu. The user interface element may, for example, be a menu component associated with a top-level menu of the hierarchical menu. The selection is made by an initial user input such as, for example, a touch input, a cursor or pointing device, and the like. The computing system then detects a touch gesture via a touch-sensitive interface, in operation 504. In particular, the touch gesture need not be continuous from the initial user input. Further, the touch gesture is detected at a location different from an area of the display device that is occupied by the menu components of the hierarchical menu. That is, a touch gesture that is registered at a location remote from the display area of the menu components can serve to control navigation of the hierarchical menu, in accordance with method 500.

The user's touch gesture may represent a movement of the top-level menu component in order to arrive at a desired menu item selection. In operation 506, the display of the top-level menu component is caused to be updated in accordance with the touch gesture. For example, the display of a selection indicator or the menu component itself may be updated based on the touch gesture, in a similar manner as described with reference to methods 300 and 400. The updated display provides a graphical representation of the user's progress in moving towards their desired menu item selection using the touch gesture.

The computing system may monitor whether contact with the touch-sensitive interface is released during the touch gesture, in operation 508. If contact is released, a check may be performed to determine whether the touch gesture is resumed on the touch-sensitive interface, in operation 510. A resumed touch gesture may indicate that the user is continuing to move towards their selection and more specifically, that the menu item associated with a most recent location of contact is not their desired selection. Upon detecting resumption of touch gesture, the method proceeds to operation 506 to continue updating the display of the top-level menu component.

In operation 512, a trigger condition in connection with the contact is detected at a first time. The trigger condition may be any one of the trigger conditions that were previously described. For example, a trigger condition relating to at least one of applied press force or dwell time of contact may be detected during the touch gesture. In response to detecting a trigger condition, a sub-menu component is caused to be displayed on the display device, in operation 514. The sub-menu component is a user interface element for the sub-menu that is associated with the selected top-menu level item. The user may then continue the touch gesture in order to cause movement of a selector element along the displayed sub-menu component.

The user's selection of the sub-menu item is determined, in operation 516. In some embodiments, the selection may be determined to correspond to the most recent location of contact prior to a release in contact that lasts for more than a defined threshold length of time. That is, if contact is released and no further contact is made within a certain time period, the computing system may determine that the user has made a selection from the sub-menu, i.e., a selection corresponding to the most recent location of contact prior to release. In some embodiments, a separate prompt may be provided on the graphical user interface for confirming a candidate selection (corresponding to the most recent location of contact). A user input in response to the prompt may serve to confirm the candidate selection as the user's selected sub-menu item.

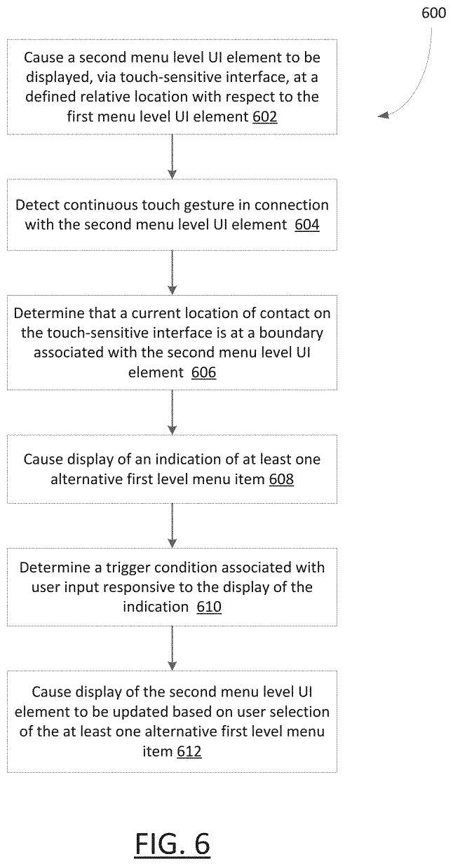

Reference is now made to FIG. 6, which shows, in flowchart form, an example method 600 for managing display of sub-menus of a hierarchical menu. The method 600 may be performed by a computing system associated with one or more merchant facilities, such as the e-commerce platform 220 of FIG. 1. For example, a merchant facility (such as the merchant facility 230) of an e-commerce platform, or components thereof (such as the interfaces module 240), may perform the operations of method 600. In particular, a computing system that is configured for providing graphical user interfaces for client devices and processing user interaction data obtained via client devices may implement the method 600. The method 600 may be performed as part of any one of methods 300, 400 and 500. By way of example, the operations of method 600 may be implemented as sub-processes of an operation (such as operation 310 of method 300) for causing a graphical representation of a sub-menu of a hierarchical menu to be displayed via a display device.

The method 600 provides a mechanism by which a user may navigate between different top-level menu items based on interaction with a menu component associated with a sub-menu. In operation 602, the computing system causes a sub-menu component to be displayed via a touch-sensitive interface, such as a touchscreen, associated with the user's client device. The sub-menu component is caused to be displayed at a fixed relative location with respect to the top-level menu.

A continuous touch gesture in connection with the sub-menu component is detected at operation 604. As the user continues the touch gesture, the location of contact on the touch-sensitive interface may be moved to a boundary associated with the sub-menu component. For example, the user may find that the sub-menu does not include a desired item selection and move the contact toward a defined graphical boundary (e.g., top, side, or bottom boundary) of the sub-menu component.

Upon determining that the current location of contact is at a boundary (operation 606), the computing system causes an indication of at least one alternative top-level menu item to be displayed, in operation 608. That is, alternative options from a parent level menu of the sub-menu may be displayed on the graphical user interface. In some embodiments, each boundary of the sub-menu component may be associated with a different alternative option from the parent level menu.

In operation 610, a trigger condition associated with user input that is responsive to the display of the alternative options is detected. The user input may, for example, be a mechanism for the user to confirm a selection of one of the alternative options. The trigger condition may be related to one or more of: dwell time of contact on or close to a boundary of the sub-menu component; touch gesture for moving contact onto a pop-up indicator of an alternative option; or applied force on or close to a boundary. The computing system then causes display of the sub-menu component to be updated based on user selection of the at least one alternative parent level menu item, in operation 612.

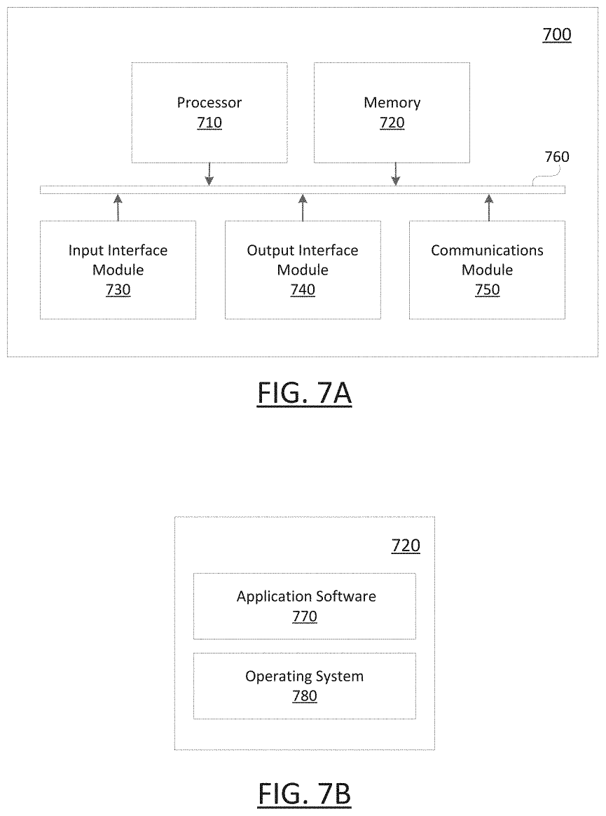

FIG. 7A is a high-level operation diagram of an example computing device 700. In at least some embodiments, the example computing device 700 may be exemplary of the client device 210. The example computing device 700 includes a variety of modules. For example, the example computing device 700, may include a processor 710, a memory 720, an input interface module 730, an output interface module 740, and a communications module 750. As illustrated, the foregoing example modules of the example computing device 105 are in communication over a bus 760.

The processor 710 is a hardware processor. For example, the processor 710 may be one or more ARM, Intel x86, PowerPC processors or the like.

The memory 720 allows data to be stored and retrieved. The memory 720 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 700.

The input interface module 730 allows the example computing device 700 to receive input signals. Input signals may, for example, correspond to input received from a user. The input interface module 730 may serve to interconnect the example computing device 700 with one or more input devices. Input signals may be received from input devices by the input interface module 730. Input devices may, for example, include one or more of a touchscreen input, keyboard, trackball or the like. In some embodiments, all or a portion of the input interface module 730 may be integrated with an input device. For example, the input interface module 730 may be integrated with one of the aforementioned example input devices.

The output interface module 740 allows the example computing device 700 to provide output signals. Some output signals may, for example allow provision of output to a user. The output interface module 740 may serve to interconnect the example computing device 700 with one or more output devices. Output signals may be sent to output devices by output interface module 740. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 740 may be integrated with an output device. For example, the output interface module 740 may be integrated with one of the aforementioned example output devices.

The communications module 750 allows the example computing device 700 to communicate with other electronic devices and/or various communications networks. For example, the communications module 750 may allow the example computing device 700 to send or receive communications signals. Communications signals may be sent or received according to one or more protocols or according to one or more standards. For example, the communications module 750 may allow the example computing device 700 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 750 may allow the example computing device 700 to communicate using near-field communication (NFC), via Wi-Fi™, using Bluetooth™ or via some combination of one or more networks or protocols. Contactless payments may be made using NFC. In some embodiments, all or a portion of the communications module 750 may be integrated into a component of the example computing device 700. For example, the communications module may be integrated into a communications chipset.

Software comprising instructions is executed by the processor 710 from a computer-readable medium. For example, software may be loaded into random-access memory from persistent storage of memory 720. Additionally, or alternatively, instructions may be executed by the processor 710 directly from read-only memory of memory 720.

FIG. 7B depicts a simplified organization of software components stored in memory 720 of the example computing device 700. As illustrated, these software components include application software 770 and an operating system 780.

The application software 770 adapts the example computing device 700, in combination with the operating system 780, to operate as a device performing a particular function. In some embodiments, the application software 770 may include a mobile application associated with a merchant's online storefront. The mobile application may allow users to access the product offerings in a merchant's store using the computing device 700.

The operating system 780 is software. The operating system 780 allows the application software 770 to access the processor 710, the memory 720, the input interface module 730, the output interface module 740 and the communications module 750. The operating system 780 may be, for example, Apple's iOS™, Android™, Linux™, Microsoft Windows™, or the like.

### Example E-commerce Platform

Although integration with a commerce platform is not required, in some embodiments, the methods disclosed herein may be performed on or in association with a commerce platform such as an e-commerce platform. Therefore, an example of a commerce platform will be described.

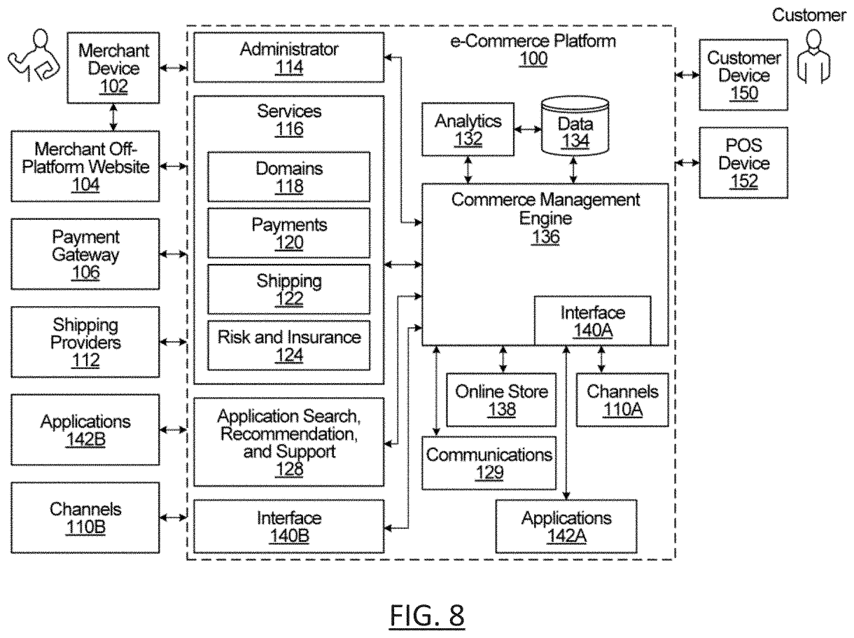

FIG. 8 illustrates an example e-commerce platform 100, according to one embodiment. The e-commerce platform 100 may be exemplary of the e-commerce platform 220 described with reference to FIG. 1. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 8, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point-of-sale (POS) devices 152 in physical locations (e.g., a physical storefront or other location such as through a kiosk, terminal, reader, printer, 3D printer, and the like).

A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point-of-sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

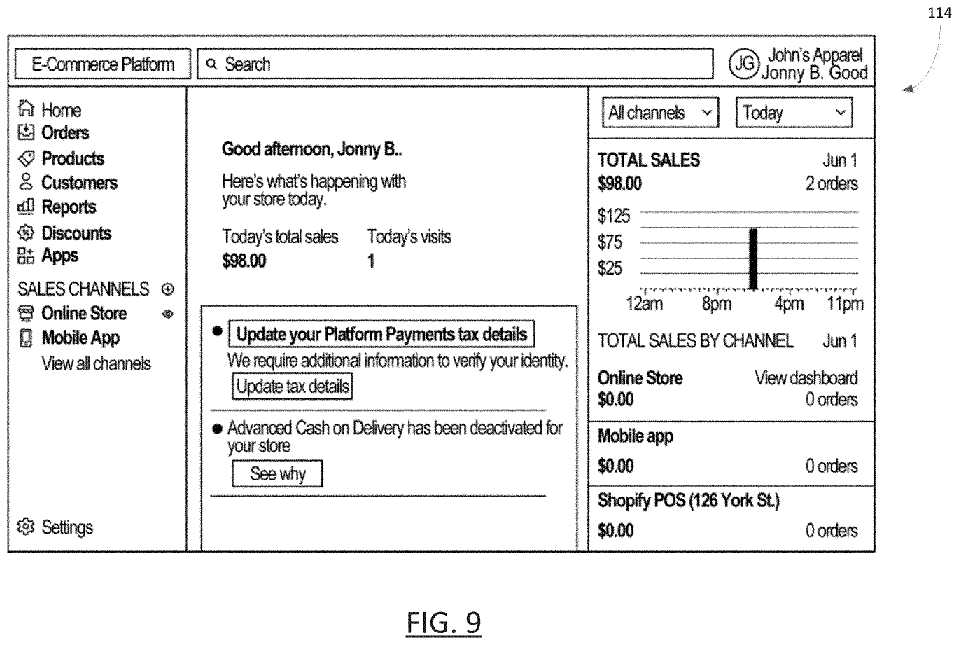

FIG. 9 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 9. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 8, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
detecting, via a touch-sensitive interface, a first touch input corresponding to selection of a user interface element associated with a first menu level of a hierarchical menu;
detecting a continuous touch gesture starting with the first touch input;
tracking a current selection of menu item of the first menu level based on a detected current location of contact with the touch-sensitive interface during the continuous touch gesture;
detecting, at a first time, a trigger condition in connection with the contact;
in response to detecting the trigger condition:
causing to be displayed, via a display device, a graphical representation of a second menu level of the hierarchical menu, the second menu level representing a sub-menu associated with a menu item of the first menu level that corresponds to the detected current location of contact at the first time;
detecting, at a second time, an end of the continuous touch gesture;
responsive to detecting the end of the continuous touch gesture,
determining a selection of menu item of the second menu level based on a location of the contact at the second time.

2. The method of claim 1, wherein the touch-sensitive interface comprises a touchscreen that is part of the display device and wherein the continuous touch gesture comprises a swiping gesture.

3. The method of claim 1, wherein the touch-sensitive interface comprises a pointing device having a tactile sensor that is separate from the display device.

4. The method of claim 1, wherein detecting the trigger condition comprises determining that an amount of force applied to the touch-sensitive interface at the current location of contact exceeds a defined force threshold.

5. The method of claim 1, wherein detecting the trigger condition comprises determining that the contact has been maintained at a location on the touch-sensitive interface corresponding to a menu item for a duration that exceeds a defined threshold length of time.

6. The method of claim 1, wherein detecting the end of the continuous touch gesture comprises detecting a release of the contact with the touch-sensitive interface.

7. The method of claim 1, wherein the user interface element associated with the first menu level comprises a first radial menu container element that contains a plurality of discrete first menu item user interface components.

8. The method of claim 1, wherein the graphical representation of the second menu level comprises a menu user interface that contains a continuous spectrum menu user interface element.

9. The method of claim 7, wherein causing to be displayed the graphical representation of the second menu level comprises causing a second radial menu container element to be displayed as an overlay on the first radial menu container, the second radial menu container element containing a plurality of discrete second menu item user interface elements associated with a selected one of the first menu items.

10. The method of claim 9, wherein the first radial menu container element comprises a base hue selector menu and wherein the second radial menu container element comprises a color spectrum menu corresponding to a selected base hue.

11. The method of claim 1, further comprising providing, via the touch-sensitive interface, at least one of a graphical indication of the current selection of menu item of the first menu level or a graphical indication of the current selection of menu item of the second menu level.

12. The method of claim 1, further comprising providing haptic feedback for indicating a change of the current selection of menu item of the first menu level during the continuous touch gesture.

13. A computing system, comprising:
a processor;
a memory coupled to the processor, the memory storing computer-executable instructions that, when executed, configure the processor to:
detect, via a touch-sensitive interface, a first touch input corresponding to selection of a user interface element associated with a first menu level of a hierarchical menu;
detect a continuous touch gesture starting with the first touch input;
track a current selection of menu item of the first menu level based on a detected current location of contact with the touch-sensitive interface during the continuous touch gesture;
detect, at a first time, a trigger condition in connection with the contact;
in response to detecting the trigger condition:
cause to be displayed, via a display device, a graphical representation of a second menu level of the hierarchical menu, the second menu level representing a sub-menu associated with a menu item of the first menu level that corresponds to the detected current location of contact at the first time;
detect, at a second time, an end of the continuous touch gesture;
responsive to detecting the end of the continuous touch gesture,
determine a selection of menu item of the second menu level based on a location of the contact at the second time.

14. The computing system of claim 13, wherein the touch-sensitive interface comprises a touchscreen that is part of a display device and wherein the continuous touch gesture comprises a swiping gesture.

15. The computing system of claim 13, wherein detecting the trigger condition comprises determining that an amount of force applied to the touch-sensitive interface at the current location of contact exceeds a defined force threshold.

16. The computing system of claim 13, wherein detecting the trigger condition comprises determining that the contact has been maintained at a location on the touch-sensitive interface corresponding to a menu item for a duration that exceeds a defined threshold length of time.

17. The computing system of claim 13, wherein detecting the end of the continuous touch gesture comprises detecting a release of the contact with the touch-sensitive interface.

18. The computing system of claim 13, wherein the user interface element associated with the first menu level comprises a first radial menu container element that contains a plurality of discrete first menu item user interface components and wherein the graphical representation of the second menu level comprises a menu user interface that contains a continuous spectrum menu user interface element.

19. The computing system of claim 18, wherein causing to be displayed the graphical representation of the second menu level comprises causing a second radial menu container element to be displayed as an overlay on the first radial menu container, the second radial menu container containing a plurality of discrete second menu item user interface elements associated with a selected one of the first menu items.

20. A non-transitory, computer-readable medium storing computer-executable instructions that, when executed by a processor, are to cause the processor to:
detect, via a touch-sensitive interface, a first touch input corresponding to selection of a user interface element associated with a first menu level of a hierarchical menu;
detect a continuous touch gesture starting with the first touch input;
track a current selection of menu item of the first menu level based on a detected current location of contact with the touch-sensitive interface during the continuous touch gesture;
detect, at a first time, a trigger condition in connection with the contact;
in response to detecting the trigger condition:
cause to be displayed, via a display device, a graphical representation of a second menu level of the hierarchical menu, the second menu level representing a sub-menu associated with a menu item of the first menu level that corresponds to the detected current location of contact at the first time;
detect, at a second time, an end of the continuous touch gesture;
responsive to detecting the end of the continuous touch gesture, determine a selection of menu item of the second menu level based on a location of the contact at the second time.
